(19) United States
(12) Patent Application Publication
(10) Pub. No.: US 2012/0288702 A1
(43) Pub. Date: Nov. 15, 2012

(54) ADHESIVE FOR BONDING POLYIMIDE RESINS

(76) Inventors: Erich Otto TEUTSCH, Pittsfield, MA (US); Craig Milne, Pittsfield, MA (US)

(21) Appl. No.: 13/104,877

(22) Filed: May 10, 2011

(51) Int. Cl. B32B 3/26; B29C 47/02; B64C 1/00; B32B 27/08; B32B 7/12; B32B 5/02; B32B 5/00; C09J 169/00; B32B 37/12; B32B 27/06

(52) U.S. Cl. 428/221; 156/325; 156/244.11; 244/133; 428/412; 428/317.7; 428/337; 428/473.5; 528/29; 428/317.1

(57) ABSTRACT

One embodiment relates to an article and a method for producing an article including a plurality of substrates, and an adhesive bonded between at least two of the plurality of substrates. The adhesive can include a polycarbonate copolymer that includes reacted resorcinol, siloxane, and bisphenol-A. Another embodiment relates to an article having a first polyimide substrate, a second polyimide substrate, and an adhesive bonded between the first substrate and the second substrate. The article can have a 2 minute integrated heat release rate of less than or equal to 65 kilowatt-minutes per square meter (kW-min/m²) and a peak heat release rate of less than 65 kilowatts per square meter (kW/m²) as measured using the method of FAR F25.4, in accordance with Federal Aviation Regulation FAR 25.853(d).

### FIELD OF THE INVENTION

The invention relates generally to an adhesive for bonding polyimide resins, and more specifically to an adhesive comprising a polycarbonate copolymer comprising reacted resorcinol, siloxane, and bisphenol-A.

### BACKGROUND OF THE INVENTION

Polyimide resins such as ULTEM® resins have excellent Flame, Smoke and Toxicity (FST) and mechanical properties and high temperature capability, but are difficult to bond and retain the FST requirements that are critical as for aircraft, marine and some rail applications. Bonding of sheets of ULTEM® foam for transportation applications or for radome construction where further machining and the retention of electrical properties such as uniform radar transparency are important is also difficult. Production of interior aircraft panels requires the application of decorative films over large areas which requires additional time in the mold to develop a high strength bond for current adhesive systems adding time and cost to production, especially if the adhesive has a limited shelf-life. Many of the existing adhesives which require high temperature cures, degrade the flame, smoke and toxicity performance or produce a gummy line when additional machining is performed at the bond line.

There are a number of adhesives that can be used for bonding ULTEM® resin in its various forms, but all of those adhesives have only limited applicability since they all fail to meet all but a few of the criteria. Most of the melt adhesives are based on flammable polymers, such as polyvinyl acetate, functionalized polyesters, etc. Such adhesives contribute sufficient fuel and even smoke and toxic combustion products and frequently adhere primarily through mechanical bonding. In the case of ULTEM® foam, bonding with these adhesives would require sufficient material to fill the open surface cells, providing even more fuel. Polyurethanes are highly effective adhesives and they give off toxic chemicals while burning. Epoxies are similar to the polyurethanes in that they may provide excellent adhesion, but epoxy adhesives can be very smoky and require extended cure time thus extending production time. Epoxy adhesives also have limited shelf life and may require refrigerated storage. Phenolic adhesives may provide very low fuel, but generally require high temperature cure and they have limited shelf life.

For critical applications, large blocks of foam had to be chosen from materials that could be made into large blocks and then machined or bonded. Any inconsistency in electrical properties, such as inconsistent radar wave absorption, would have to be compensated for electronically or by use of additional devices.

Therefore, there is a need for an adhesive capable of bonding polyimide resin containing materials to each other where the adhesive has excellent Flame, Smoke and Toxicity (FST) properties, excellent electrical properties, as well as excellent mechanical properties. Such adhesives show great utility when used to bond polyimide materials to each other, and/or bond materials to polyimide resins.

### BRIEF SUMMARY OF THE INVENTION

A first embodiment relates to an article comprising a plurality of substrates, and an adhesive bonded between at least two of the plurality of substrates, wherein the adhesive comprises a polycarbonate copolymer comprising reacted resorcinol, siloxane, and bisphenol-A.

A second embodiment relates to an article comprising a first polyimide substrate; a second polyimide substrate; and an adhesive bonded between the first substrate and the second substrate, wherein the article has a 2-minute integrated heat release rate of less than or equal to 65 kilowatt-minutes per square meter (kW-min/m2) and a peak heat release rate of less than 65 kilowatts per square meter (kW/m2) as measured using the method of FAR F25.4, in accordance with Federal Aviation Regulation FAR 25.853(d).

A third embodiment relates to an adhesive comprising a polycarbonate copolymer comprising reacted resorcinol, siloxane, bisphenol-A. The adhesive of this embodiment may take the form of a hot-melt adhesive, a film, or a woven or non-woven fabric. The adhesive does not affect electrical properties, has no shelf-life limitation, and can be made available in a broad range of colors. The adhesive can be machined after bonding.

A fourth embodiment relates to a method comprising bonding a first substrate to a second substrate with an adhesive comprising a polycarbonate copolymer comprising reacted resorcinol, siloxane, and bisphenol-A.

A fifth embodiment relates to a method comprising bonding of polymers and materials other than polyimides to each other. In such an embodiment, the adhesive can be used to bond non-polyimide containing substrates or other materials together.

### BRIEF DESCRIPTION OF THE DRAWINGS

FIG. 1 is a schematic representation of two pieces of polyimide foam bonded by the adhesive of the invention;

### DETAILED DESCRIPTION OF THE INVENTION

The present invention may be understood more readily by reference to the following detailed description of preferred embodiments of the invention as well as to the examples included therein. In the following detailed description and in the claims which follow, reference will be made to a number of terms which shall be defined to have the following meanings:

All numeric values are herein assumed to be modified by the term “about,” whether or not explicitly indicated. The term “about” generally refers to a range of numbers that one of skill in the art would consider equivalent to the recited value (i.e., having the same function or result). In many instances, the term “about” may include numbers that are rounded to the nearest significant figure. All percentages are weight percentages, unless otherwise indicated.

The invention described herein addresses all of the above limitations at least for any of the ULTEM® resin and EXTEM® resin grades. LEXAN® FST resin can be used as a very effective hot-melt adhesive for the above mentioned resins within a useful temperature range to avoid distortion of the parts, but still be functional over a broad temperature range. It has no measurable effect on the FST characteristics, does not embrittle the bond line, has no shelf life limitation, can be used as film, woven or non-woven fabric, does not affect electrical properties, can be available in a broad range of colors and can be machined readily after bonding. The LEXAN® FST resin may also be useful for bonding to resins other than ULTEM® or EXTEM®.

LEXAN® FST resin is a terpolymer that happens to be fully compatible with ULTEM®, but has a T_{g} almost 70° C. lower than ULTEM®. Due to the composition it is also very similar to ULTEM® with respect to the FST properties and can be extruded into sheet, thin film, fiber and be injection molded. Film of LEXAN® FST can be extruded to provide a thin uniform layer of film that can serve to bond ULTEM® foam to foam, ULTEM® sheet to foam or ULTEM® foam to injection molded parts and anything containing substantial amounts of ULTEM® resin such as ULTEM® resin based glass fiber or carbon fiber composites. The film can even be used to mold in reinforcement during thermoforming of ULTEM® based products such as CAB (Composite Aircraft Board) or to adhere the decorative surface film or fabric onto the molded CAB panels. The LEXAN® FST film can also be used to bond ULTEM® sheet and or film or fabric continuously, for instance by using a continuous belt press or a heated roll stand, etc. When bonding foam sheets into large blocks, it can be done using a standard bagging process, since only light pressure is required to form a good bond at 200° C. Temperatures as low as 160° C. can be used depending on how high a pressure the individual parts can survive at the specific temperature.

LEXAN® FST is more fully described in U.S. patent application Ser. Nos. 11/426,680, filed Jun. 27, 2006; 11/025, 635, filed Dec. 29, 2004 and U.S. Pat. Nos. 6,841,482, issued Mar. 1, 2005; 6,610,409, issued Aug. 26, 2003 and 6,306,507, issued Oct. 23, 2001, the entire disclosures of which are herein incorporated by reference.

Other resins are being evaluated both for use in the same manner as the LEXAN®FST and to determine if LEXAN®FST can bond to them as well. Polyethylene terephalate (PET), for instance will bond to ULTEM® readily, but has greatly inferior flammability characteristics and depending on the degree of crystallinity may exhibit a much higher bonding temperature than even ULTEM® resin can withstand. The FST film should also be suitable for bonding this non-polyimide material with LEXAN® FST.

The process for bonding ULTEM® foam into multiple layered blocks using FST film is simple and direct.

Sheets of ULTEM® foam 10, 20} are interleafed with a 2 mil, or preferably 3 mil, extruded FST film 15, and heated under light pressure (10 to 15 psi) to 385° F. After holding under those conditions for 10 to 15 minutes the article is allowed to cool. The hold time may be eliminated for more than 3 layers, since heat transfer is rather poor, ULTEM® foam being a good insulator, will require some time to cool down to 100° F. to 125° F. providing ample hold time. It is advisable to insert a thermocouple the first time a construction is laminated to determine the proper length of time needed to reach 385° F. in the core layer. Subsequent run schedules can be based on the time required to reach the proper core temperature during the initial run. The samples were tested only to see if the bond failure was adhesive or cohesive and in all cases was found to be cohesive in the foam next to the bond.

Thin layers of ULTEM® film were also bonded to foam board from 2 to 25 mm thick with excellent results. In other experiments Foam was bonded to sheets of aircraft grade opaque LEXAN® FSTresin with equally good results. ULTEM® 1000 film was also bonded to ULTEM® 5001 film using 50_m FST film with excellent results. To form a good bond to EXTEM® resin required higher pressures and 410° F. Kapton® film did not appear to adhere at the settings used for ULTEM®, but was not tested under more extreme conditions. Get this data! A first embodiment relates to an article comprising a plurality of substrates, and an adhesive bonded between at least two of the plurality of substrates, wherein the adhesive comprises a polycarbonate copolymer comprising reacted resorcinol, siloxane, and bisphenol-A. One or more of the plurality of substrates can be a polymer substrate. One or more of the plurality of substrates can be a polyimide substrate. One or more of the plurality of substrates can be selected from the group of polyimide foams, polyimide composites, polyimide fabrics, polyimide films, injection-molded polyimide articles, compression molded polyimide articles, Polyimide composite sheets and combinations thereof. One or more of the plurality of substrates can be a polymeric foam. One or more of the plurality of substrates can be a film having a thickness ranging from more than 0 and less than 0.75 cm. One or more of the plurality of substrates can be an injection molded article. One or more of the plurality of substrates can be a compression-molded article. One or more of the plurality of substrates can be a fabric. The article can be selected from the group of radomes, fuselages, wings, structured products, structured cores, stow bins, galley panels, lavatory walls, dividers, structured panels, and other articles with related performance requirements. The article can have a 2-minute integrated heat release rate of less than or equal to 65 kilowatt-minutes per square meter (kW-min/m2) and a peak heat release rate of less than 65 kilowatts per square meter (kW/m2) as measured using the method of FAR F25.4, in accordance with Federal Aviation Regulation FAR 25.853(d).

A second embodiment relates to an article comprising a first polyimide substrate; a second polyimide substrate; and an adhesive bonded between the first substrate and the second substrate, wherein the article has a 2-minute integrated heat release rate of less than or equal to 65 kilowatt-minutes per square meter (kW-min/m2) and a peak heat release rate of less than 65 kilowatts per square meter (kW/m2) as measured using the method of FAR F25.4, in accordance with Federal Aviation Regulation FAR 25.853(d). The first polyimide substrate can be selected from the group of polyimide foams, polyimide composites, polyimide fabrics, polyimide films, injection-molded polyimide articles, compression molded polyimide articles, and combinations thereof. The second polyimide substrate can be selected from the group of polyimide foams, polyimide composites, polyimide fabrics, polyimide films, injection-molded polyimide articles, compression molded polyimide articles, and combinations thereof. The adhesive can comprise a polycarbonate copolymer comprising reacted resorcinol, siloxane, and bisphenol-A.

A third embodiment relates to an adhesive comprising a polycarbonate copolymer comprising reacted resorcinol, siloxane, bisphenol-A.

A fourth embodiment relates to a method comprising bonding a first substrate to a second substrate with an adhesive comprising a polycarbonate copolymer comprising reacted resorcinol, siloxane, and bisphenol-A. The adhesive can be an extruded film having a thickness in a range of from at least 0.5 mil to 3 mil. The adhesive film can be thinner or thicker than 2-3 mil depending on the surface smoothness and fit of the mating surfaces. The smoother and closer fitting the surfaces are the thinner the film can be and still give an effective bond. The practical limits are due to the conversion process, which could be blown, cast or extruded film ranging upward from perhaps 0.5 mil. The first substrate and the second substrate can be bonded at a temperature in a range of from 160 to 350 degrees Celsius.

A fifth embodiment relates to a method comprising bonding of polymers and materials other than polyimides to each other. In such an embodiment, the adhesive can be used to bond non-polyimide containing substrates or other materials together. In one embodiment, the adhesive is in a form selected from the group of foams, cloths tapes, powders, fibers, papers, and combinations thereof.

The following Table lists some of the physical properties of the ULTEM 1000, ULTEM 5000 and EXTEM and EXTEM 1000 brand polyimide materials

Upper Limits

ULTEM 1000=210 degrees Celsius,

ULTEM 5000 or EXTEM near or just above Tg.
ULTEM 5000 Tg is 224 degrees Celsius

Extem Tg=247-310 degrees Celsius

Ultem 1000 Tg=217 degrees Celsius
A first substrate and a second substrate can be bonded at a pressure in a range of from 0.1 to 40 bar. The method can further comprise introducing reinforcing fibers to the adhesive. The fibers can comprise polycarbonate copolymer comprising reacted resorcinol, siloxane, and bisphenol-A. Reinforcing fibers can be included with the adhesive film to strengthen or stiffen the construction. Other components, such as sensors and/or conductors can also be included with the adhesive film. In another embodiment, the first substrate and the second substrate are bonded at a pressure in a range of from 0.1 to 15 bar.

Although the present invention has been described in detail with reference to certain preferred versions thereof, other variations are possible. Therefore, the spirit and scope of the appended claims should not be limited to the description of the versions contained therein.

### EXAMPLES

### Examples 1-9

Different article components were made using polycarbonate polysiloxane copolymers according to various embodiments.

### Materials

Table 1 lists materials employed in the examples.

TABLE 1

| Material | Name/Description | Source |
|---|---|---|
| PolyimideA | Ultem ® 1000 | SABIC Innovative Plastics |
| Polyimide B | Ultem ® 5001 | SABIC Innovative Plastics |
| Polyimide C | EXTEM ® XH 1005 | SABIC Innovative Plastics |
| Polyimide D | KAPTON | DuPont |
| | poly(4,4′-oxydiphenylene- | |
| | pyromellitimide). | |
| Polyetherketone | PEEK | Victrex |
| Polycarbonate | LEXAN ® FST | SABIC Innovative Plastics |
| Copolymer | | |
| ULTEM ® foam | | |
| LEXAN ® FST | | |

### Techniques & Procedures

Articles were made that illustrate the process for binding two polyimide substrates of various kinds with a polysiloxane polycarbonate, in accordance with various embodiments.

1. Techniques/Procedure for Making Article Components with Two Polyimide Foams

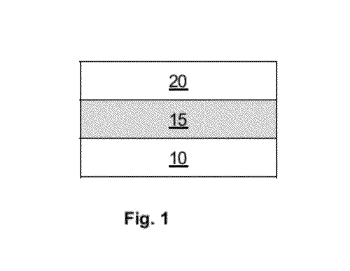

As shown in FIG. 1, the following components were assembled and bonded together into a block using two Wabash presses.
2 pieces (10, 20) of extruded ULTEM® foam board XP060 1″×14″×16″
1 piece (15) of 50 μm LEXAN® FST extruded film 15″×17″ as an adhesive layer. The components were stacked in the order as shown in FIG. 1. A press plate was placed on top and bottom of the assembly, which was then put into the first Wabash press preheated to 196 degrees Celsius. The press was closed to provide 3 bar pressure and held under those conditions for 20 minutes, after which the stack was placed into the second press set at 100 degrees Celsius for cooling. After removal from the cooling press and allowing the stack to cool to room temperature the stack was trimmed and cut into two roughly equal pieces for evaluation. All of the bond lines appeared to be sound and breaking individual layers of a 1″ strip apart resulted in cohesive failure of the foam.
   2. Techniques/Procedure for Making Article Components with Two Polyimide Composites

Four sets of nominally 6 mm×30 mm×170 mm ULTEM® fiber/carbon fiber composites were prepared by stacking two 3 mm strips of the composite with a 50 μm LEXAN® FST film nominally 30 mm×170 mm interposed between the composite strips. The stacks were arranged around the perimeter of an induction heated tool set for maximum temperature. Due to design limitations the tool was only able to reach approximately 200 degrees Celsius. At that temperature and a pressure of 4 bar the ULTEM® composite did not melt or distort, but the LEXAN® FST melted causing an excellent bond to form between the adjacent composite surfaces.

3. Techniques/Procedure for Making Article Components with a Polyimide Foam and a Polyimide Composite

An approximately 2 mm×150 mm×150 mm piece of extruded ULTEM® foam was placed between two pieces of 50 μm LEXAN® FST film as an adhesive layer slightly larger in size than the foam. The stack was then placed between two sheets of 75 μm ULTEM® film slightly larger than the LEXAN® FST film. The assembly was placed between two pieces of heavy gauge aluminum foil treated with a release agent (MAC 1031) which was placed in a small press set at 195 degrees Celsius and approximately 3 bar were applied for 6 minutes. The foil and composite stack were then transferred to a second press set to 120 degrees Celsius for cooling. After approximately three minutes the assembly was removed from the cooling press. The aluminum was removed easily from the stack. The film/foam/film construction was fully bonded without any apparent damage to the foam and a smooth surface.

### 4. Techniques/Procedure for Making Article Components With a Fabric and a Polyimide Composite

A piece of ULTEM® resin and carbon fiber composite was covered with a 50 μm LEXAN® FST film. A piece of nylon fabric was placed on top of the film. The assembly was placed between two titanium sheets, which had been treated with release agent and placed into a press set to 180 degrees Celsius and 5 bar pressure for 6 min. Upon cooling in a second press set to 100 degrees Celsius for 3 minutes the assembly was removed and allow to cool to near room temperature. The fabric appeared unaffected by the process and was securely attached to the composite.

5. Techniques/Procedure for Making Article Component with Two Films and a Polyimide Film

A 125 μm sample of extruded ULTEM® 1000-1000 film was covered on both sides with LEXAN® FST film. A layer of extruded 25 μm ULTEM® 5001 film was then added to both sides. The stack of films was placed between two sheets of high strength aluminum foil that had been treated with release agent (MAC 1031) on the contact surfaces. The whole assembly was placed into a press set to 195 degrees Celsius for 6 minutes at 4 bar pressure, after which time it was placed into a cooling press at room temperature for ˜2 min. Upon removal from between the aluminum foil both films of ULTEM® 5001 were securely bonded to the ULTEM® 1000 film. A small area where the LEXAN® FST film had slipped on the top side and thus had no LEXAN® FST film between it and the ULTEM® 1000 film and the ULTEM® 5001 film was not bonded.

6. Techniques/Procedure for Making Article Component with Two Films and a Polyimide Foam

An approximately 2 mm×150 mm×150 mm piece of extruded ULTEM® foam was placed between two pieces of 50 μm LEXAN® FST film slightly larger in size than the foam. The stack was then placed between two sheets of 75 μm ULTEM® film slightly larger than the LEXAN® FST film. The assembly was placed between two pieces of heavy gauge aluminum foil treated with a release agent (MAC 1031) which was placed in a small press set at 195 degrees Celsius and approximately 3 bar were applied for 6 minutes. The foil and composite stack were then transferred to a second press set to 120 degrees Celsius for cooling. After approximately three minutes the assembly was removed from the cooling press. The aluminum was removed easily from the stack. The film/foam/film construction was fully bonded without any apparent damage to the foam and a smooth surface.

7. Techniques/Procedure for Making Article Components with Injection Molded Articles

An electrical connector molded of ULTEM® glass filled resin was bonded to tray of injection molded ULTEM® with the flat rim of the connector making contact with the tray. A piece of 75 μm LEXAN® FST film was trimmed to just slightly larger than the contact area and placed between the tray and the connector. The assembly was placed into a press set to 200 degrees Celsius. The press was closed to exert a light pressure on the area of the film and the assembly was allowed to heat to a uniform temperature. The assembly was then moved to a cooling press and allowed to cool to near room temperature prior to removing from the cooling press. The connector was securely bonded to the tray without any distortion of either part.

8. Techniques/Procedure for Making Article Components with Extruded Articles

A piece of extruded ULTEM® 1000 sheet was placed on a piece of extruded EXTEM® XH 1005 sheet. A piece of 50 μm LEXAN® FST film was placed between them so that only half of the ULTEM® sheet and the EXTEM® sheet were exposed to the LEXAN® FST film. The assembly was placed between titanium plates that had been treated with MAC 1031 to insure easy release of any of the components. The assembly was then placed into a press set to 210 degrees Celsius. A pressure of 5 bars was applied and the assembly was allowed to heat up to the set temperature over a period of 8 minutes, after which time the assembly was placed into a cooling press under similar pressure and set to 100 degrees Celsius for ˜3 minutes. After removal from the press the assembly was allowed to cool to room temperature. The ULTEM® and the EXTEM® extruded sheets were securely bonded, but only where the LEXAN® FST was disposed between them.

9. Techniques/Procedure for Making Article Components with Compression Molded Articles

A hollow container was formed from two compression molded bowls. Bowls were compression molded from consolidated sheet of multiple layers of ULTEM® fiber and carbon fiber fabric. Sufficient layers of fabric to form a 3 mm thick plate on consolidation were placed between sheets of polished aluminum that had been treated with high temperature release agent (MAC 1031) and then were placed into a press set to 175 degrees Celsius and the temperature was slowly raised to 360 degrees Celsius. Pressure was slowly applied once the temperature had reached 210 degrees Celsius, until the pressure reached 35 bar. The pressure and temperature were held at those conditions for 15 min. at that point the cooling was begun under pressure until the press platens reached 260 degrees Celsius. The pressure was then slowly reduced while the press was further cooled to 50 degrees Celsius. The press was opened and the plate removed from the cooling press.

The composite plate was wrapped in high temperature release film, reheated to 360 degrees Celsius, placed on the bottom half of a compression tool and the press closed, forcing the male part of the tool to form the softened composite sheet into the shape of a bowl. Both halves of the compression tool were heated to about 190 degrees Celsius to permit controlled cooling of the composite while still permitting deformation to occur.

Once two bowls had been compression molded and the rim cleaned and sanded flat LEXAN® FST film was placed between the edges of the bowls. The thus formed hollow container was strapped with steel bands and over springs on the bottom of the bowls. The assembly was placed in a forced hot air oven set to 195 degrees Celsius and held at that temperature for 10 min. After cooling the banding was removed. The bowls had been securely joined together by the LEXAN® FST film melt adhesive.

### 10. Heat Testing Procedure

Heat release testing was done on 15.2×15.2 cm plaques 2.0 mm thick using the Ohio State University (OSU) rate-of-heat release apparatus, as measured by the method listed in FAR 25.853. Heat release was measured at two-minutes in kW-min/m² (kilowatt minutes per square meter). The peak heat release was measured as kW/m2

(Kilowatt per square meter). The time to maximum heat release, in minutes, was also measured. The heat release test method is also described in the “Aircraft Materials Fire Test Handbook” DOT/FAA/AR-00/12, Chapter 5 “Heat Release Test for Cabin Materials”.

### 11. Peel Strength Testing

The articles made by the foregoing Examples were subjected to standard peel testing procedures. The peel testing procedure ISO 8510-1; 1990 was used. ISO 8510-1; 1990 is a 90 degree peel test of a flexible bonded to a rigid test specimen substrate. The flexible film is fixtured in a tensile test machine grip and pulled and the resulting peel force is measured. Peel strength is typically reported in pounds/linear inch.

Although the present invention has been described in considerable detail with reference to certain preferred versions thereof, other versions are possible. Therefore, the spirit and scope of the appended claims should not be limited to the description of the preferred versions contained herein.

All the features disclosed in this specification (including any accompanying claims, abstract, and drawings) may be replaced by alternative features serving the same, equivalent or similar purpose, unless expressly stated otherwise. Thus, unless expressly stated otherwise, each feature disclosed is one example only of a generic series of equivalent or similar features.

Any element in a claim that does not explicitly state “means for” performing a specified function, or “step for” performing a specific function, is not to be interpreted as a “means” or “step” clause as specified in 35 U.S.C §112, sixth paragraph. In particular, the use of “step of” in the claims herein is not intended to invoke the provisions of 35 U.S.C §112, sixth paragraph.

What is claimed is:

1. An article comprising a plurality of substrates, and an adhesive bonded between at least two of the plurality of substrates, wherein the adhesive comprises a polycarbonate copolymer comprising reacted resorcinol, siloxane, and bisphenol-A.

2. The article of claim 1, wherein at least one of the plurality of substrates is a polymer substrate.

3. The article of claim 1, wherein at least one of the plurality of substrates is a polyimide substrate.

4. The article of claim 1, wherein at least one of the plurality of substrates is selected from the group of polyimide foams, polyimide composites, polyimide fabrics, polyimide films, injection-molded polyimide articles, compression molded polyimide articles, and combinations thereof.

5. The article of claim 1, wherein at least one of the plurality of substrates is a polymeric foam.

6. The article of claim 1, wherein at least one of the plurality of substrates is a film having a thickness ranging from more than 0 and less than 0.75 cm.

7. The article of claim 1, wherein at least one of the plurality of substrates is an injection molded article.

8. The article of claim 1, wherein at least one of the plurality of substrates is a compression-molded article.

9. The article of claim 1, wherein at least one of the plurality of substrates is a fabric.

10. The article of claim 1, wherein the article is selected from the group of radomes fuselages, wings, structured products, structured cores, stow bins, galley panels, lavatory walls, dividers, and structured panels.

11. The article of claim 1, wherein the article has a 2 minute integrated heat release rate of less than or equal to 65 kilowatt-minutes per square meter (kW-min/m²) and a peak heat release rate of less than 65 kilowatts per square meter (kW/m²) as measured using the method of FAR F25.4, in accordance with Federal Aviation Regulation FAR 25.853(d).

12. An article comprising:
(a) a first polyimide substrate;
(b) a second polyimide substrate;
(c) an adhesive bonded between the first substrate and the second substrate, wherein the article has a 2 minute integrated heat release rate of less than or equal to 65 kilowatt-minutes per square meter (kW-min/m²) and a peak heat release rate of less than 65 kilowatts per square meter (kW/m²) as measured using the method of FAR F25.4, in accordance with Federal Aviation Regulation FAR 25.853(d).

13. The article according to claim 12, wherein the first polyimide substrate is selected from the group of polyimide foams, polyimide composites, polyimide fabrics, polyimide films, injection-molded polyimide articles, compression molded polyimide articles, and combinations thereof.

14. The article according to claim 12, wherein the second polyimide substrate is selected from the group of polyimide foams, polyimide composites, polyimide fabrics, polyimide films, injection-molded polyimide articles, compression molded polyimide articles, and combinations thereof.

15. The article according to claim 12, wherein the adhesive comprises a polycarbonate copolymer comprising reacted resorcinol, siloxane, and bisphenol-A.

16. An adhesive comprising a polycarbonate copolymer comprising reacted resorcinol, siloxane, bisphenol-A.

17. A method comprising bonding a first substrate to a second substrate with an adhesive comprising a polycarbonate copolymer comprising reacted resorcinol, siloxane, and bisphenol-A.

18. The method of claim 17, wherein the adhesive is an extruded film having a thickness in a range of from at least 0.5 mil to 3 mil.

19. The method of claim 17, wherein the adhesive is in a form selected from the group of foams, cloths tapes, powders, fibers, papers, and combinations thereof.

20. The method of claim 17, wherein the first substrate and the second substrate are bonded at a temperature in a range of from 160 to 350 degrees Celsius.

21. The method of claim 17, wherein the first substrate and the second substrate are bonded at a pressure in a range of from 0.1 to 40 bar.

22. The method of claim 20, wherein the first substrate and the second substrate are bonded at a pressure in a range of from 0.1 to 15 bar.

23. The method of claim 17, wherein the method further comprises introducing reinforcing fibers to the adhesive.

24. The method of claim 22, wherein the reinforcing fibers are selected from the group of carbon fibers, glass fibers, and combinations thereof.

25. The method of claim 21, wherein the fibers comprise polycarbonate copolymer comprising reacted resorcinol, siloxane, and bisphenol-A.
